(19) United States
(12) Patent Application Publication
(10) Pub. No.: US 2002/0138312 A1
(43) Pub. Date: Sep. 26, 2002

(54) Right to use vacation interest resort business method

(76) Inventor: Joseph D. Blau, Scarsdale, NY (US)

Correspondence Address: OLTMAN, FLYNN & KUBLER, 915 MIDDLE RIVER DRIVE, SUITE 415, FORT LAUDERDALE, FL, 33304, US

(21) Appl. No.: 09/816,704

(22) Filed: Mar. 26, 2001

(51) Int. Cl. G06F 17/60

(52) U.S. Cl. 705/5; 705/14

(57) ABSTRACT

A method of operating a membership club with an increasing number of benefits and amenities, featuring the Right to Use Vacation Interest affiliated resort apartment via an exchange organization using a computer. The apartment will increase in size and, based on member seniority, the length of the stay increases as well. Expenses are sharply reduced by the inapplicability of State timeshare laws; no need for deeds, mortgages or trust deeds; no notes or other form of personal liability; the members right to terminate at will without any form of debt; and finally no need for “hard sell tactics”.

### BACKGROUND OF THE INVENTION

1. Field of the Invention

This invention relates to the creation of an entirely novel membership club that, by using an established resort exchange organization with 1800 affiliated resort condominium apartments, provides club members with an annual right to use a different fully furnished apartment with many other benefits and privileges, all without making a purchase or incurring a debt. Expenses are sharply reduced by the inapplicability of State timeshare laws; no need for deeds, mortgages or trust deed; no notes or other form of personal liability; and the members right to terminate at will without any form of debt.

2. Prior Art

At present, to participate in a vacation timeshare or exchange program requires a substantial commitment on the part of a new owner. Usually, the new owners must purchase a real estate interest for a specified time interval in a timeshare residential unit of a vacation resort to be entitled to use that residential unit or a comparable unit in another vacation resort having an exchange arrangement with the resort wherein the owner has purchased. The owner receives from his/her vacation resort a deed to a specific apartment or villa in that resort. Typically, the new owner makes a down payment and executes a mortgage or trust deed for the unpaid balance of the total purchase price of the unit involved, payable in monthly installments, with a seven to ten year maturity at an interest rate of 14% to 17%. Alternatively, the new owner may be issued a right to use a particular unit in the Owner's resort by signing a debt instrument akin to a conditional bill of sale, carrying a similar obligation to make monthly payments at a relatively high interest rate over a significant number of years. This is a continuing obligation that is not extinguished by the owner's default in making the monthly payments.

Either way, the common practice in the timeshare industry is to require both husband and wife to assume the payment obligation and other obligations contained in the mortgage, trust deed, or conditional bill of sale. The liability of each is joint and several to reduce the occurrence of false claims by one or the other of false oral representation made on behalf of the resort before the agreement was executed.

Timeshare resorts are affiliated with to an exchange organization which processes the exchange arrangements for owners of different resorts, such that an owner at A can exchange his/her right to use the designated apartment or villa in Resort A for the use of a similar unit in resort B, if one is available. A leading organization of this type is Interval International (II) of Miami, Fla., with whom the club is affiliated. For an owner of any resort to be eligible for an exchange through the exchange organization, that owner must have a present right to use a residential unit in the owner's resort, so that unit is listed with the exchange organization for availability to an owner of another affiliated resort. Also, for owners to be eligible to use the exchange privileges of the exchange organization, a resort pays fees to the exchange organization and must show the resort's compliance with all applicable state laws and regulations. Owner must also pay to be a member of exchange organization and pay an additional fee to exchange their unit.

Perceived abuses in the vacation timeshare industry have led to the enactment of buyer protection state laws and regulations applicable to timeshare arrangements involving either an interest in realty or a right to use under a debt instrument. Compliance with these myriad state laws and regulations added to the cost of doing business on the part of developers of vacation resorts of this type. Consequently, a timeshare developer's marketing costs (including the cost of compliance with state laws and regulations) typically account for 40% to 50% of gross sales. These marketing costs are reflected in the price a member pays for his/her use of a timeshare unit.

### SUMMARY OF THE INVENTION

The present invention is a business method which avoids the foregoing and other disadvantages associated with conventional ways of doing business in the vacation resort timeshare industry.

In accordance with the present invention, a member's financial obligations are limited to payment of a one-time Club enrollment fee and regular dues payments for the Right to Use Vacation Interest, for a designated period of time each year after an initial startup period, a designated residential unit located in the Club's home resort in the Club's head resort and the right to use an available comparable unit an affiliated resort having exchange privileges with the member's resort via the exchange organization. By not making a dues payment the member abandons his/her right to use the Right to Use Vacation Interest unit and automatically terminates his/her obligation to make additional dues payments. Contrary to timeshare obligations, the member's obligations are terminable at the will of the member. The member's non-payment, of course, means that he/she is no longer a member of the resort he/she joined and is no longer entitled to any of the rights conferred by membership.

The resort owner's cost of doing business—including but not limited to, the costs of attracting prospective members, enrolling them as members, paying commissions to sales agents for attracting new members to the resort, keeping track of each member's right to use, processing payments from the members (in the form of credit card charges), and keeping track of member eligibility—are minimized by the mandatory extensive use of computers and the Internet to process all the transactions and do the necessary record keeping. Because of this cost reduction, the resort owner is able to offer, in addition to a new member's specified right to use a Right to Use Vacation Interest unit, additional amenities which increase over time, making it more attractive for a member to stay and take advantage of these increasing amenities or benefits. This, in turn, is advantageous to the resort owner because it tends to stabilize the membership base to people who have shown themselves appreciative of the benefits of membership and are compatible with the spirit of the resort, and obviating the cost of attracting new members to replace those who leave. The complexity of the administrative process mandates unique application software.

Further advantageous aspects of this invention will be apparent from the following detailed description of a presently preferred embodiment thereof, illustrated by the flow charts of the accompanying drawings.

### BRIEF DESCRIPTION OF THE DRAWINGS

FIG. 1 is a flow chart depicting an overview of the novel business method of the present invention;

FIG. 2 is a flow chart relating to the interface between a Club member and the Club to which he/she belongs;

FIG. 3 is a flow chart showing the progression of a Club member's rights, which increase the longer the membership continues, and the steps by which the Club's computer system manages this sequence;

FIG. 4 is a flow chart depicting the exchange process for a member seeking use of a Right to Use Vacation Interest unit in an affiliated resort other than the unit in the Club's lead resort; and

FIG. 5 is a flow chart relating to commission payments from the Club to sales agents after a member joins.

### DETAILED DESCRIPTION OF THE INVENTION

Before explaining the present invention in detail it is to be understood that the invention is not limited in its application to the particular arrangement shown and described herein since the invention is capable of other embodiments. Also, the terminology used herein is for the purpose of description and not of limitation. In the following description and claims and in the drawings, “the Club” is just that, a club that members join and “the Exchange Organization” refers to the organization with which the Club and other vacation resorts are affiliated to facilitate a member's use of a residential unit in another Right to Use Vacation Interest resort, in accordance with the exchange organization's practice.

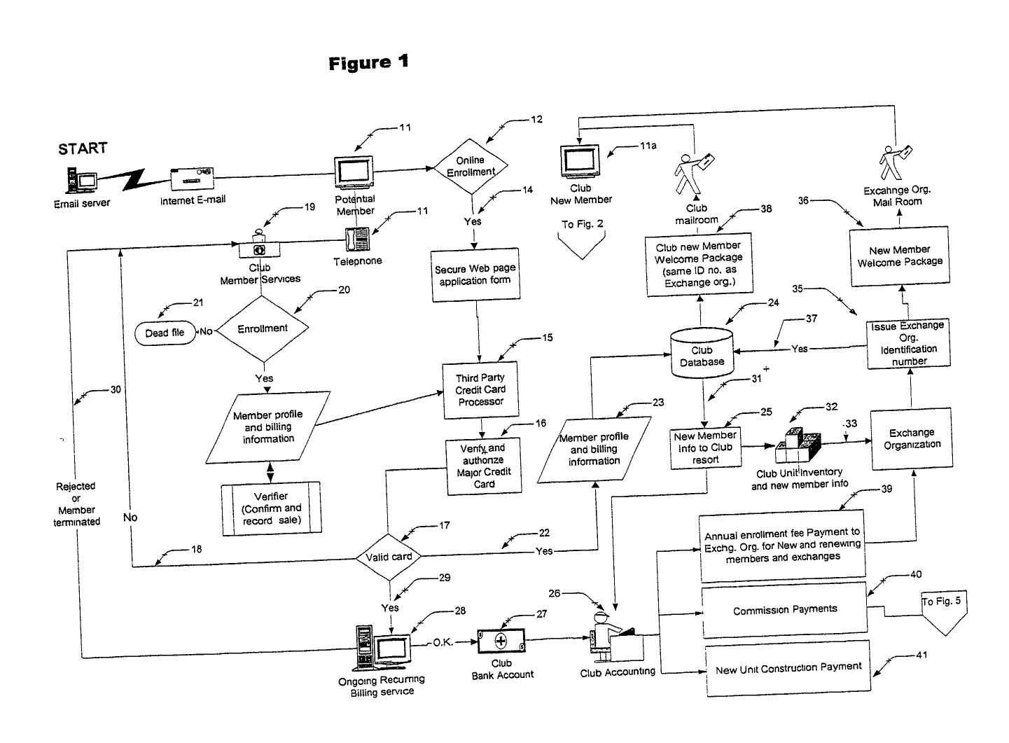

### Overview—FIG. 1

Referring to FIG. 1, the principal way a prospective new member communicates with the Club is via the World Wide Web, which a prospective member can use to access the Club's web site from the prospective member's computer 11. The Web also is the principal way established members and the Club communicate with each other, although communication by regular mail, Fax, e-mail and telephone are other ways that may be used.

The initial contact with a prospective member may be made on the Club's behalf by a telemarketer, sales organization or independent sales representative. Alternatively, the prospective member may first learn about the Club via public media. However the first contact is made, if interested, a prospective member can contact the Club by e-mail 12 or by phone 13. It is anticipated that most prospective members will use e-mail.

Using e-mail, the first step in the member enrollment process is to fill out a membership application form 14 which the Club e-mails to the prospective member upon his or her indication of an interest in joining. Part of the information the prospective member provides in filling out this form is to designate the major credit card (e.g., Visa, MasterCard, or American Express) he/she will use to pay the Club's one-time enrollment fee and the periodic membership fee. This credit card information is verified (15, 16 and 17) by a third party credit card processing company.

If the prospective member's credit card is not valid, that information is transmitted via line 18 to the Club's member services department 19, which record's the credit card's invalidity in the Club's enrollment database 20, after which the prospective member's application is stored in a dead file 21 in the Club's database, and the prospective member is notified of his or her rejection by phone 13.

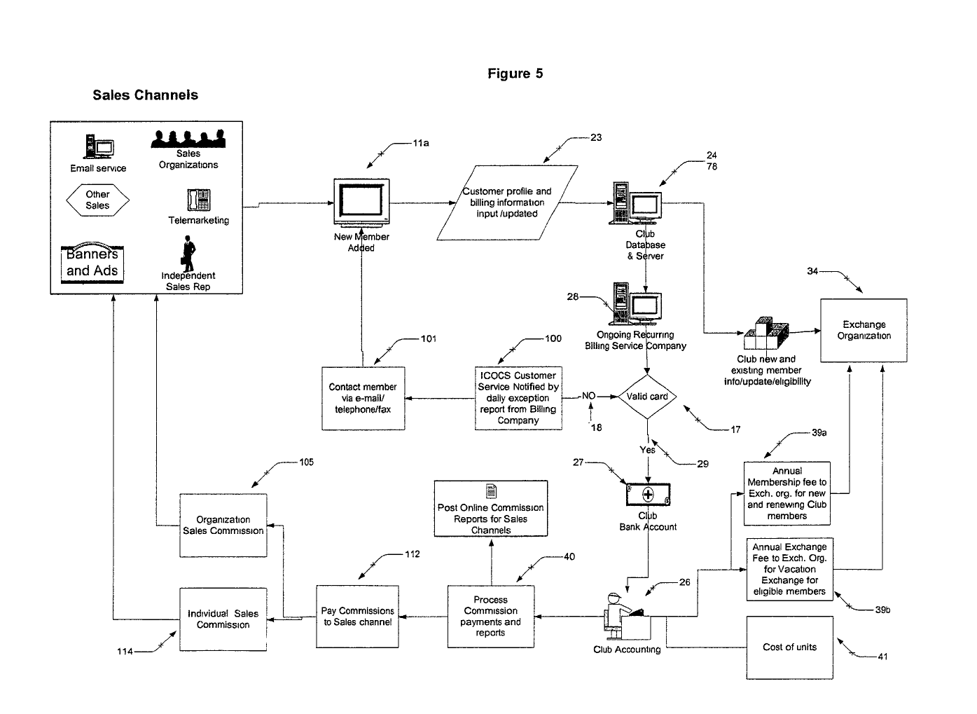

If the prospective member's card is valid, that determination is transmitted via line 22 to the Club's member profile and billing information database 23,which is part of the Club's main database 24 but is shown separately in FIGS. 1 and 5 to facilitate the description. From database 24 information on the new member is transmitted to the Exchange organization 25, which immediately allocates the right to use one of the Club resort's Right to Use Vacation Interest residential units for a specified interval of time (such as the right to use a villa in the Club resort for one week during the new member's second year of membership in the Club).

The Club 25 promptly transmits the new member information and the right to use allocation given that member to the Club's accounting department 26. The accounting department also receives information pertaining to the new member's account with the Club from the Club's bank account database 27, which receives information on (a) the current status of the new member's credit card and (b) the new member's current balance in the Club bank account 27 from an ongoing recurring billing service computer 28, which receives notice of the validity of the new member's credit card via line 29. The ongoing billing service computer 29 also notifies the Club's member services department 19 via line 30 whenever (a) the prospective new member's application for membership in Club is rejected or (b) a member's Club membership is terminated, such as by non-payment of the monthly fee.

When a new member joins, the Club's main database 24 transmits information about the new member to the Club 25 and via line 31 to the Club's database 32 of information about new members and the inventory of the available Right to Use Vacation Interest units. That information is transmitted via line 33 to an existing computer installation 34 maintained by the Exchange Organization, an association to which 1800 Right to Use Vacation Interest resorts presently belong.

The Exchange Organization issues an identification number for the new Club member, and this becomes part of a new member welcome package 36 that is transmitted to the new member's computer, which for convenience of description is identified in FIG. 1 separately as 11a, to reflect the new member's changed status from prospective to accepted member of Club but actually is the same computer 11 used by the new member when he or she was just a prospective member. The Exchange Organization's New member package is sent via US Mail and not transmitted to the new member's computer. This is because the member receives an actual membership card, coupons and printed membership information on exchanges, etc. The Exchange Organization also transmits this new member identification number via line 38 to the Club's main database 24, which responds to this by issuing to the new member's computer 11a the Club's new member welcome package. The Club's new member package is sent via US Mail and not transmitted to the new member's computer. This is because the member receives an actual membership card, coupons and printed membership information on exchanges, etc.

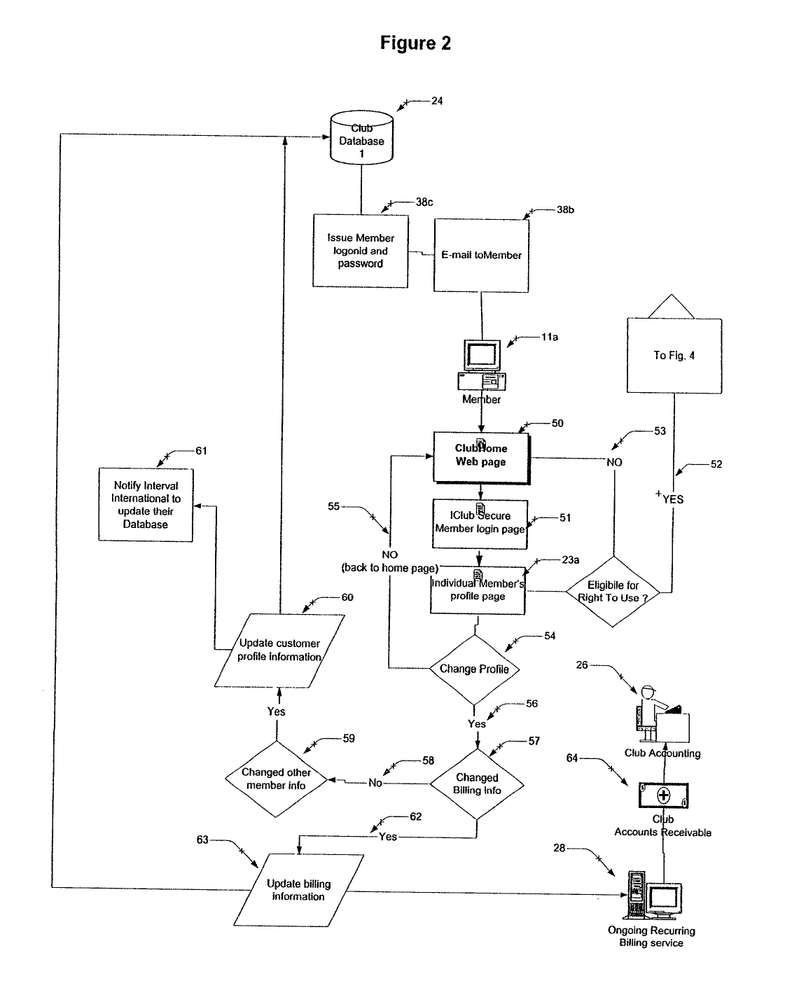

### Member-Club Interface—FIG. 2

Referring to FIG. 2, after a prospective member is accepted for membership, from its database 24 the Club issues the new member a log on identification and password 38a, which are to be used by the member in all future Internet communications with the Club. (The log on ID and password are part of the Club's new member welcome package 38 in FIG. 1). The member log on ID and password are e-mailed (38b) to the member's computer 11a. The member now logs onto the Club's home page on the Web (part of its database 24), and from there the member enters his/her log on ID and password in the Club's secure member log in page 51. The member can now access his/her individual profile page 23a in the Club's database 24.

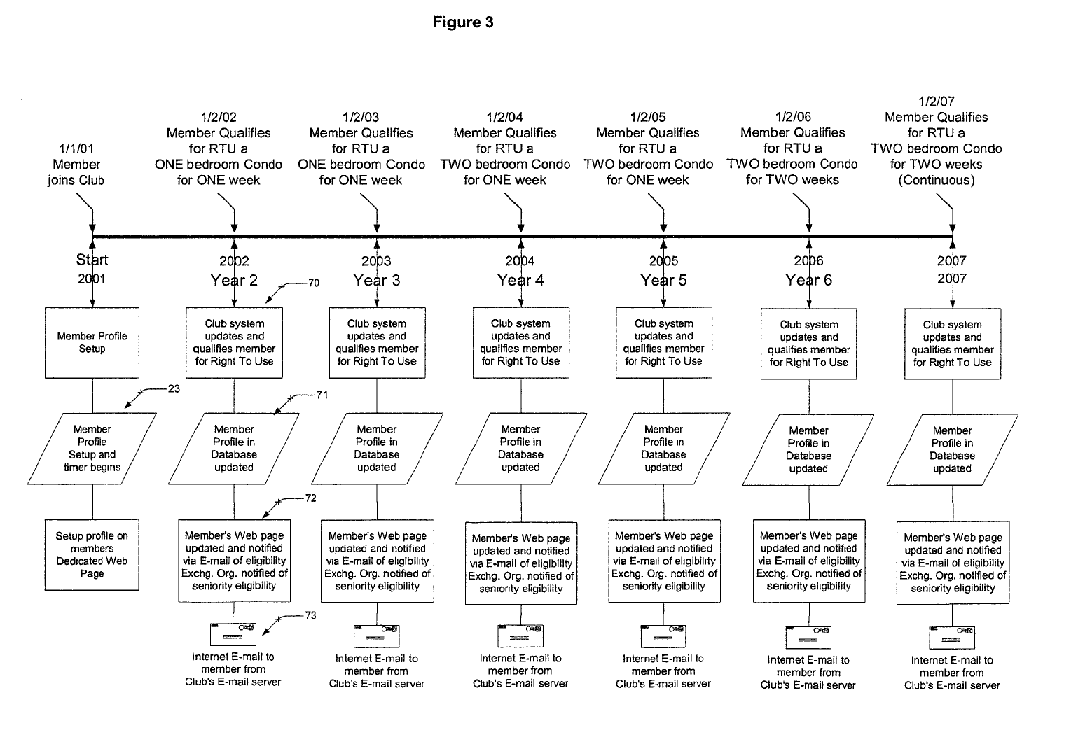

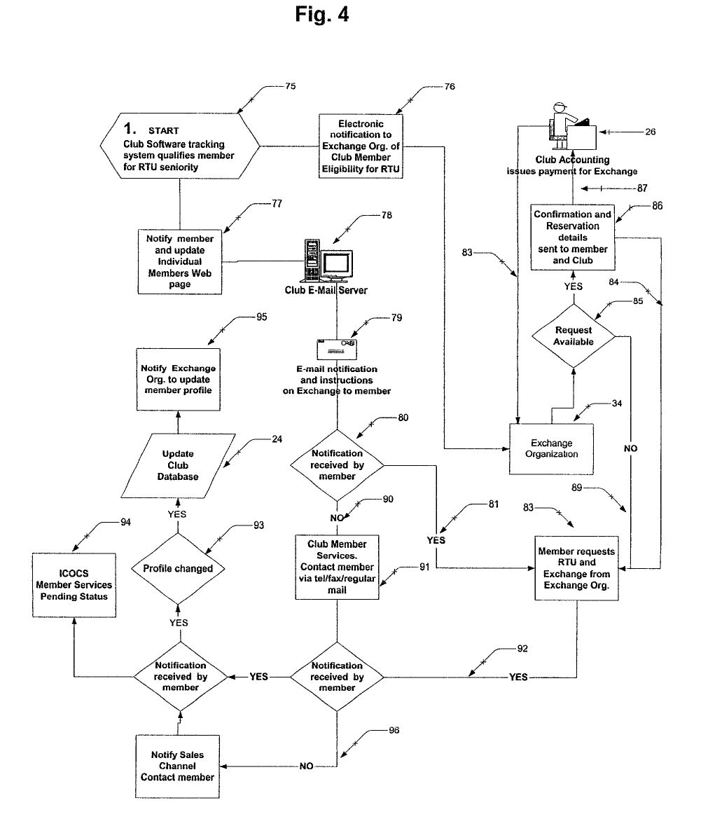

When the member has belonged to the Club long enough to have earned Right to Use Vacation Interest benefits, as explained hereinafter with reference to FIG. 3, that new Right to Use Vacation Interest status (52) is automatically signaled to block 75 in FIG. 4, which relates to a member's exercise of his right to exchange use of a residential unit in the Club for use of a comparable unit in one of the other resorts affiliated with the Exchange Organization. If the new member has not yet earned any Right to Use Vacation Interest benefit, that status (53) is signaled to the Club's home Web page 50.

The “change profile” block 54 immediately below the “member's profile page” block 23a in FIG. 2 indicates the system's automatic response to a change in the member's profile. In no change (55), that unchanged status remains stored in the Club's home page on the Web 50. If the Club member's profile does change (56), this may or may not change the billing information about the member 57.

If the member's billing information is unchanged (58), then the member's profile change 54 means a change in member information other than billing information 59. The updated non-billing information on the member 60 is automatically transmitted to the Club's database 24 and to the Exchange Organization's database 61.

When the member's billing information does change (62), the updated billing information 63 on this member is automatically transmitted to the Club's database 24 and to the Club's ongoing, recurring billing service 28 (FIG. 1), which keeps the Club's accounting department 26 up to date with respect to the Club's accounts receivables 64.

### Increasing Member Benefits with Time—FIG. 3

FIG. 3 shows in successive vertical columns from left to right the steps by which the Club's computer continually updates the member's status with the Club and makes available increasing member benefits as the years of membership go by.

In the first year (e.g., 2001) a new member's profile is established and kept up to date as the member makes periodic dues payments to the Club after paying the one-time enrollment fee. After one membership year the member is entitled to the Right to Use Vacation Interest a one bedroom unit at the Club's home resort or in another affiliated exchange organization resort at a mutually satisfactory time. The member's dues payments to the Club for the second year of his/her membership qualify the member to a tight to use a two bedroom unit for one week.

After the fourth year the member's dues payments will have qualified the member to an upgrade to a two bedroom unit for two weeks, either in the Club or in another resort affiliated with the Exchange Organization, and annually thereafter.

Taking year 2 as the prototype for all the years that follow, the Club's computer system, which has continually updated the member's status as he/she made periodic dues payments for year 1, now qualifies the member for the Right to Use Vacation Interest a one bedroom unit for one week during year 2. This is indicated by block 70 in FIG. 3. During this year the Club's computer continues to keep track of the member's periodic dues payments (block 71).

During year 2 the Club's computer system also performs the following functions: (a) updating the member's web page and notifying the member by e-mail of the rights he/she has earned; and (b) notifying the Exchange Organization by e-mail of the member's current rights under the agreement 72 between the Club and the Exchange Organization.

All communications from the Club to the member are sent by e-mail from the Club's server to the member's Web page 73.

In following years the same procedure is followed.

### Vacation Unit Exchange—FIG. 4

Referring to FIG. 4, it is the Club's responsibility under its agreement with the Exchange Organization to track the Right to Use Vacation Interest eligibility of each Club member (block 75) and to notify the Exchange Organization of the current status and extent of each Club member's Right to Use Vacation Interest (76), as explained with reference to FIG. 3.

The Club also notifies each member of their Right to Use Vacation Interest status (77). The Club's e-mail server 78 sends all necessary notices to each Club member by e-mail 79, together with instructions to the member about his/her right to exchange the use of one of the Club's units for use of a comparable unit, when available, in any other resort belonging to the same Exchange Organization as the Club. In FIG. R the block 80 (“notification received by member”) represents the member's acknowledgment back to the Club that the member has received an e-mail from the Club that the member is now eligible for a specified Right to Use Vacation Interest.

After the member receives such notification he/she may decide to request such an exchange for this year 83 in a resort, which the member designates, by e-mail (81)or may decide not to request an exchange but instead use the Club's home resort.

When the Club member e-mails to the Exchange Organization a request for an exchange this year (84), the Exchange Organization 34 grants the request if a suitable unit is available 85, confirms a reservation for the Club member in the resort he/she has designated, and sends details of this reservation to the Club member 86.

After the Club member has completed his/her use of the exchange unit, the Exchange Organization notifies the Club's accounting department 26 of such exchange use by e-mail (87), and the Club's accounting department then issues a payment (88) to the Exchange Organization for processing this exchange transaction requested by the Club member. The amount of this payment is determined by the Exchange Organization and is subject to change.

If the Exchange Organization has to deny the Club member's request because of the unavailability of a suitable exchange unit in the designated resort for the time period specified in the request, the Exchange Organization notifies the Club member of that denial by e-mail (89). That denial also is e-mailed to the Club's member services department 94.

The Club's computer will receive a negative response from its Internet service provider (i.e., a notice that the Club member did not receive his/her Right to Use Vacation Interest eligibility e-mail notice from the Club) if any of the following situations has occurred: (a) the member's e-mail account with his/her Internet service provider has expired, or (b) has been canceled by the member, or (c) the member has changed his/her Internet service provider (and thus the member's e-mail address), or (d) for some other reason the member's e-mail just is not functioning properly. If the Club receives such a negative response, the procedure to correct this situation begins with the NO line (90) under the “Notification received by member” block 80 in FIG. 4.The Club's member services department tries to contact the member some way other than e-mail, such as by phone, fax, or conventional mail.

If the Club does manage to get in touch with the member 91 and notify the member of his/her Right to Use Vacation Interest eligibility, the member may initiate an exchange request (line 92) to the Exchange Organization.

The member's profile 93 in the Club's database 24 also is changed, and the Club's member services department 94 has notice of the member's pending (i.e., in good standing) status. The Club also notifies the Exchange Organization to update this member's profile 95.

If, however, the Club's member services department is unable to contact the member by phone, fax or regular mail, it notifies the sales organization that attracted the member to the Club, giving that organization the opportunity to communicate with the member so that the member can get in touch with the Club.

### Sales Commission and Other Payments—FIG. 5

FIG. 5 is a flow chart depicting how the Club allocates a member's dues payments to the Club for several purposes intrinsic to the Club's business operation, including, the payment for the cost of the unit (apartment), making payments to the Exchange organization, and paying sales commissions to the sales organization or individual sales person who attracted the member to the Club.

When a new member joins the Club 11a, the Club establishes a continuously updated member profile and billing information database 23 (which is part of the Club's complete database 24). The Club's ongoing, recurring billing service 28 (which may be operated by the Club or by an outside organization) process member payments to the Club's bank account 27 by charging the member's credit card 17. If ever the member's credit card is reported no longer valid (18) that fact is communicated immediately to the Club's member service department 100, which first attempts to notify the member by e-mail, and if that fails by telephone and fax (101).

As member's dues are deposited into the Club's bank account 27 the Club's accounting department 26 makes two types of payments to the Exchange Organization 34 (although the two are lumped together in one block 39 in FIG. 1). The Club makes an annual membership payment 39a to the Exchange Organization for the member, and the Club also pays an annual exchange fee 39b entitling the member to the exchange privileges made available by the Exchange Organization, as already explained.

Another portion of the member's dues payments to the Club goes to the Club 41 to pay for the cost of the units as indicated.

Additionally, some of the member's periodic payments to the Club is processed at 40 to generate commission payments 102 to whichever sales organization 105 or individual 104 brought the Club to the member's attention. Also, reports 103 are produced concerning these sales commission payments.

It is essential that the system ensures that one week is deposited by the Club for each week of Right to Use Vacation Interest based on member's seniority status.

While the foregoing description and the accompanying flow charts disclose the presently preferred features of this invention, it is to be understood that the invention is susceptible of modifications which do not depart from its essential principles.

I claim:

1. A method of operating a vacation resort Right to Use Vacation Interest business by a Right to Use Vacation Interest Club having a computer and a plurality of residential units for Right to Use Vacation Interest use by Club members, comprising the steps of:
enrolling a new member in the Club's computer database contingent upon the new member's payment of an enrollment fee to the Club and the new member's agreement for regular dues payments through the member's designated credit card throughout a membership period that is terminable at will by the member;
initially verifying the member's designated credit card and monitoring its status with the credit card issuer throughout said membership period;
establishing and maintaining in the Club's computer database a member profile page for the new member and a continuing record of the dues payments to the member's designated credit card;
and providing the member the Right to Use Vacation Interest a vacation unit for the applicable period based upon the length of the member's membership through the Exchange Organization.

2. A method according to claim 1 wherein the Club has an exchange agreement with an Exchange Organization having similar agreements with other Right to Use Vacation Interest vacation resorts whereby a Club member can exchange use of a residential unit in the Club for use of a comparable available unit in one of said other Right to Use Vacation Interest resorts, and further comprising the steps of:
from the Club's computer database, communicating to the Exchange Organization information on the new Club member for enabling the new Club member's enrollment in the Exchange Organization;
through the Club's computer, notifying the Exchange Organization of the member's eligibility, based on seniority, for an exchange;
and from the Club's computer, notifying the Exchange Organization whenever the Club member is no longer eligible for exchanges.

3. A method according to claim 2, and further comprising the step of: from a portion of the Club member's enrollment fee and periodic credit card charges paid to the Club, making payment from the Club to the Exchange Organization for the Club member's membership and exchange privileges in the Exchange organization.

4. A method according to claim 3, and further comprising the step of: from another portion of the Club member's enrollment fee and periodic credit charges paid the Club, making payments to a fund for the cost of club vacation resort facilities.

5. A method according to claim 4, and further comprising the step of: from another portion of the Club member's enrollment fee, making a commission payment to the sales group or party who attracted the member to the Club.

6. A method according to claim 3, and further comprising the step of: from another portion of the Club member's enrollment fee, making a commission payment to a sales agent who attracted the member to the Club.

7. A method according to claim 1, and further comprising the step of: from a portion of the Club member's enrollment fee and periodic credit charges paid the Club, making payments for the cost of club vacation resort facilities.

8. A method according to claim 1, and further comprising the step of: from a portion of the Club member's enrollment fee, making a commission payment to a sales agent who attracted the member to the Club.

9. A method according to claim 1, and further comprising the steps of:
from a portion of the Club member's enrollment fee and periodic credit charges paid the Club, making payments to a fund for future construction of additional vacation resort facilities of the Club;
and from another portion of the Club member's enrollment fee, making a commission payment to a sales agent who attracted the member to the Club.

10. A method according to claim 1 wherein, member enrollment takes place by e-mail between the new member and the Club.

11. A method according to claim 1 wherein the Club issues to the member a log on identification and a password for e-mail communications between the member and the Club.

12. A method according to claim 1 wherein the Club's computer tracks the member's membership and assigns Right to Use Vacation Interest benefits to the member which increase with time.

13. A method according to claim 12 wherein the Club notifies the member by e-mail of the current terms of the member's Right to Use Vacation Interest.

14. A method according to claim 12 wherein the Club establishes an individual Web page for exclusive access by the member and updates said Web page as to the current terms of the member's Right to Use Vacation Interest.
